(19) United States
(12) Patent Application Publication
(10) Pub. No.: US 2026/0205152 A1
(43) Pub. Date: Jul. 16, 2026

(54) HUB DEVICE

(71) Applicant: Sharp Kabushiki Kaisha, Osaka (JP)

(72) Inventor: Tatsuya NISHIO, Sakai City (JP)

(21) Appl. No.: 19/398,354

(22) Filed: Nov. 24, 2025

(30) Foreign Application Priority Data
Jan. 15, 2025 (JP) 2025-005166

(51) Int. Cl. H04B 1/40

(52) U.S. Cl. CPC H04B 1/40

(57) ABSTRACT

In a hub device 6, wireless communication transceivers 7 are connected to respective ones of a plurality of USB ports 63 arranged in the hub device 6, and the plurality of USB ports 63 are arranged such that a distance L1 between the adjacent USB ports 63 is equal to or greater than half a wavelength of an antenna frequency of the wireless communication transceivers 7, and insertion/removal directions into the USB ports 63 are arranged radially in the hub device 6.

### INCORPORATION BY REFERENCE

This application is based upon and claims the benefit of priority from the corresponding Japanese Patent Application No. 2025-005166 filed on Jan. 15, 2025, the entire contents of which are incorporated herein by reference.

### BACKGROUND

The present disclosure relates to a hub device that connects a plurality of wireless devices via a plurality of wireless communication transceivers corresponding to respective ones of the wireless devices.

Conventionally, a system is known that enables a plurality of users to hold a conversation using audio devices, each including a microphone and a speaker. For example, a system is known that includes a plurality of audio devices (personal communication devices) and a hub device installed in a meeting space, to which the plurality of audio devices can simultaneously connect via a local network, thereby enabling conversation using the plurality of audio devices.

For example, in a configuration where a plurality of audio devices are connected to a network using USB connection type wireless communication transceivers (e.g., Bluetooth transmitters (Bluetooth: registered trademark)), it is necessary to connect (insert) a plurality of wireless communication transceivers, one for each audio device, into the hub device. In this case, for example, when a plurality of audio devices operating in a common frequency band are arranged in close proximity to the hub device, radio interference occurs, resulting in a problem of deterioration in audio communication quality. Furthermore, a configuration in which adjacent wireless communication devices are spaced apart to prevent radio interference is conceivable; however, this configuration results in a problem of an increase in the size of the hub device.

### SUMMARY

An object of the present disclosure is to provide a hub device that can connect to wireless communication transceivers corresponding to respective ones of a plurality of wireless devices, and that can prevent deterioration in communication quality of the plurality of wireless devices while also preventing an increase in the size of the hub device.

A hub device according to one aspect of the present disclosure is a hub device that can connect to a plurality of wireless communication transceivers corresponding to respective ones of a plurality of wireless devices that operate using a common frequency band, and that enables wireless communication of the wireless devices. In the hub device, the wireless communication transceivers are connected to respective ones of a plurality of connection sections arranged in the hub device, the plurality of connection sections being arranged such that a distance between the adjacent connection sections is equal to or greater than half a wavelength of an antenna frequency of the wireless communication transceivers, and such that an insertion/removal direction into the connection sections is arranged radially in the hub device.

According to the present disclosure, it is possible to provide a hub device that can connect to wireless communication transceivers corresponding to respective ones of a plurality of wireless devices, and that can prevent deterioration in communication quality of the plurality of wireless devices while also preventing an increase in the size of the hub device.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram illustrating an application example of an audio processing system according to an embodiment of the present disclosure.

FIG. 2 is a block diagram illustrating a configuration of the audio processing system according to the embodiment of the present disclosure.

FIG. 3 is a diagram schematically illustrating an application example of an audio processing device according to the embodiment of the present disclosure.

FIG. 4 is a plan view illustrating a configuration of a hub device according to Example 1 of the present disclosure.

FIG. 5 is a plan view illustrating a configuration of a wireless communication transceiver according to the embodiment of the present disclosure.

FIG. 6 is a diagram illustrating antenna directivity of the wireless communication transceiver according to the embodiment of the present disclosure.

FIG. 7 is a plan view illustrating a configuration of the hub device according to Example 1 of the present disclosure.

FIG. 8 is a plan view illustrating a configuration of a hub device according to Example 2 of the present disclosure.

FIG. 9 is a plan view illustrating a configuration of a hub device according to Example 3 of the present disclosure.

FIG. 10 is a plan view illustrating a configuration of a hub device according to Example 4 of the present disclosure.

FIG. 11 is a plan view illustrating a configuration of a hub device according to an other embodiment of the present disclosure.

### DETAILED DESCRIPTION

Hereinafter, embodiments of the present disclosure will be described with reference to the accompanying drawings. Note that the following embodiments are examples embodying the present disclosure and do not have the nature of limiting the technical scope of the present disclosure.

The hub device according to the present disclosure is a device that can connect to a plurality of wireless communication transceivers corresponding to respective ones of a plurality of wireless devices that operate using a common frequency band, and that enables wireless communication of the wireless devices. In this embodiment, a configuration will be described in which the hub device is applied to an audio processing system that performs audio communication. Note that the hub device is not limited to audio communication and can be applied to a data communication system that performs various types of data communication.

The audio processing system according to the present embodiment can be applied, for example, to a case where a plurality of users in the same space (e.g., a meeting room) each use an audio device (an example of a wireless device of the present disclosure) including a microphone and a speaker to hold a conversation (meeting) with users in an other space. Note that the audio processing system can also be applied to a case where a plurality of users in one space each use an audio device to hold a conversation. Furthermore, the audio processing system can also be applied to a case where one user in one space uses an audio device to hold a conversation with users in an other space.

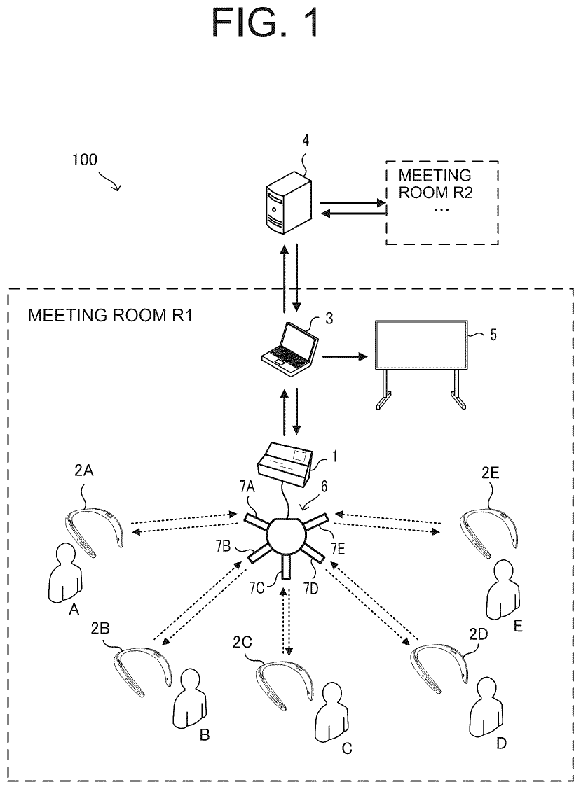

FIG. 1 illustrates an application example of an audio processing system 100 according to the present embodiment. As illustrated in FIG. 1, users A to E participate in the meeting in meeting room R1, and other users (not illustrated) participate in the meeting in meeting room R2. The users A to E hold a conversation using neckband-type audio devices 2A to 2E, respectively, which can be worn around the neck. The user in meeting room R2 may use an audio device 2, or may use a single microphone-speaker device installed in meeting room R2. Note that the audio devices 2A to 2E may be audio devices of the same model, or may be audio devices of different models. Also, the audio devices 2A to 2E may be audio devices that include only a microphone and do not include a speaker. Also, the audio devices 2A to 2E may be known general-purpose audio devices. For example, the audio device 2 may be a pin-type, gooseneck-type, handheld-type, or desktop-type microphone device.

Each audio device 2 in meeting room R1 is wirelessly connected (Bluetooth connection) to an audio processing device 1 via a wireless communication transceiver 7 (Bluetooth transmitter (Bluetooth: registered trademark)) connected (inserted) to a hub device 6. Audio input to the microphone of each audio device 2 is input to the audio processing device 1 via each wireless communication transceiver 7, transmitted from the audio processing device 1 via a meeting terminal 3 and a meeting server 4, and output (reproduced) from the speakers of the audio devices 2 (or the microphone-speaker device) of the users in meeting room R2. Also, the audio input to the microphone of the audio device 2 (or the microphone-speaker device) in meeting room R2 is transmitted via the meeting server 4, the meeting terminal 3, the audio processing device 1, and each wireless communication transceiver 7, and is reproduced from the speakers of the audio devices 2 of the users in meeting room R1.

As described above, the audio processing system 100 is a system that enables a plurality of users to individually use audio devices 2 to hold a conversation in the same space (meeting room R1 in FIG. 1). The audio processing system 100 may include a display device 5 usable in the meeting. The display device 5 displays meeting information such as camera images of meeting participants and meeting materials by a meeting application, or displays recognition results (text information) obtained by converting audio to text through speech recognition processing.

As illustrated in FIG. 1, the audio processing system 100 includes an audio processing device 1, audio devices 2, a meeting terminal 3, a meeting server 4, a hub device 6, and wireless communication transceivers 7. The audio device 2 is a wireless connection type acoustic device equipped with a microphone and a speaker. Note that the audio device 2 may include functions such as an AI speaker or a smart speaker. The audio processing system 100 includes a plurality of audio devices 2 and is a system that transmits and receives audio data of user's uttered audio with the plurality of audio devices 2.

The hub device 6 can connect to a plurality of wireless communication transceivers 7 corresponding to respective ones of a plurality of audio devices 2 that operate using a common frequency band (e.g., 2.4 GHz band), and that enables wireless communication for each audio device 2. Note that a plurality of audio devices 2 operating in different frequency bands may be connected to the hub device 6. The wireless communication transceiver 7 is, for example, a USB-type Bluetooth transmitter that includes a USB connector (USB terminal) and has a configuration that allows it to be inserted into a USB port of the hub device 6. The audio device 2 and the wireless communication transceiver 7 are wirelessly connected by executing a pairing process based on the Bluetooth standard.

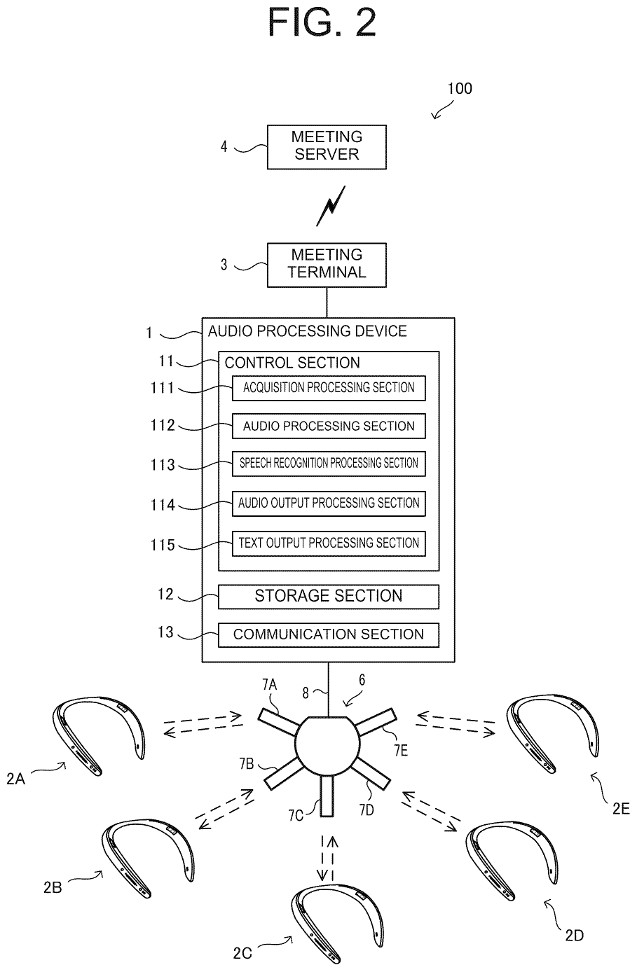

As illustrated in FIG. 2, the hub device 6 is connected to a wireless communication transceiver 7A paired with the audio device 2A, a wireless communication transceiver 7B paired with the audio device 2B, a wireless communication transceiver 7C paired with the audio device 2C, a wireless communication transceiver 7D paired with the audio device 2D, and a wireless communication transceiver 7E paired with the audio device 2E. Specifically, the wireless communication transceivers 7 are connected to respective ones of a plurality of USB ports 63 arranged in the hub device 6. Each of the audio devices 2A to 2E is connected so as to be able to wirelessly communicate with a respective one of the wireless communication transceivers 7A to 7E.

The audio processing device 1 controls audio (input audio, output audio, etc.) of the audio device 2, and executes processing to transmit and receive audio to and from the plurality of audio devices 2 when, for example, a meeting starts in a meeting room. For example, the audio processing device 1 controls the audio of a plurality of audio devices 2 that are arranged in the same space. Also, the audio processing device 1 stores the audio acquired from the audio devices 2 as audio for recording, or executes processing (speech recognition processing) to convert the acquired audio into text.

Furthermore, the audio processing system of the present disclosure may include various servers that provide various services, such as a meeting service, a subtitle (transcription) service using speech recognition, a translation service, and a meeting minutes service. The present embodiment includes the meeting server 4, which provides a meeting service. The meeting server 4 provides an online meeting service of a meeting application, which is a type of general-purpose software. For example, the meeting application is installed on the meeting terminal 3. By starting the meeting terminal 3 and logging in, it becomes possible to hold an online meeting (e.g., an online meeting in meeting room R1 and meeting room R2) using the meeting application.

### Audio Processing Device 1

As illustrated in FIG. 2, the audio processing device 1 is a device including a control section 11, a storage section 12, a communication section 13, and the like. For example, the audio processing device 1 is configured with a device (e.g., a mixer box) that is connected to the plurality of audio devices 2 and includes a function of mixing or splitting audio input from the plurality of audio devices 2 or the meeting terminal 3.

The communication section 13 is a communication section for connecting the audio processing device 1 to a communication network via a wired or wireless connection, and executing data communication with external devices, such as the audio devices 2 and the meeting terminal 3, via the communication network according to a predetermined communication protocol. For example, the communication section 13 is connected to the hub device 6 via a cable 8 and performs data communication with the hub device 6.

The storage section 12 is a non-volatile storage section, such as a Hard Disk Drive (HDD), Solid State Drive (SSD), or flash memory that stores various types of information. Specifically, the storage section 12 may store data such as information that enables identification of the audio devices 2 (device number, device ID, etc.).

Also, the storage section 12 stores a control program for causing the control section 11 to execute predetermined processing. For example, the control program may be non-transitorily recorded on a computer-readable recording medium such as a CD or DVD, read by a reading device (not illustrated) such as a CD drive or DVD drive included in the audio processing device 1, and stored in the storage section 12.

The control section 11 includes control devices such as a CPU, ROM, and RAM. The CPU is a processor that executes various types of arithmetic processing. The ROM is a non-volatile storage section in which control programs, such as a BIOS and an OS, for causing the CPU to execute various types of arithmetic processing, are pre-stored. The RAM is a volatile or non-volatile storage section that stores various types of information, and is used as a temporary storage memory (work area) for various types of processing executed by the CPU. Then, the control section 11 controls the audio processing device 1 by executing various control programs pre-stored in the ROM or the storage section 12 with the CPU.

Specifically, as illustrated in FIG. 2, the control section 11 includes various processing sections such as an acquisition processing section 111, an audio processing section 112, a speech recognition processing section 113, an audio output processing section 114, and a text output processing section 115. Note that the control section 11 functions as the various processing sections with the CPU executing various types of processing according to the control program. Also, part or all of the processing sections may be configured with electronic circuits. Note that the control program may be a program for causing a plurality of processors to function as the processing sections.

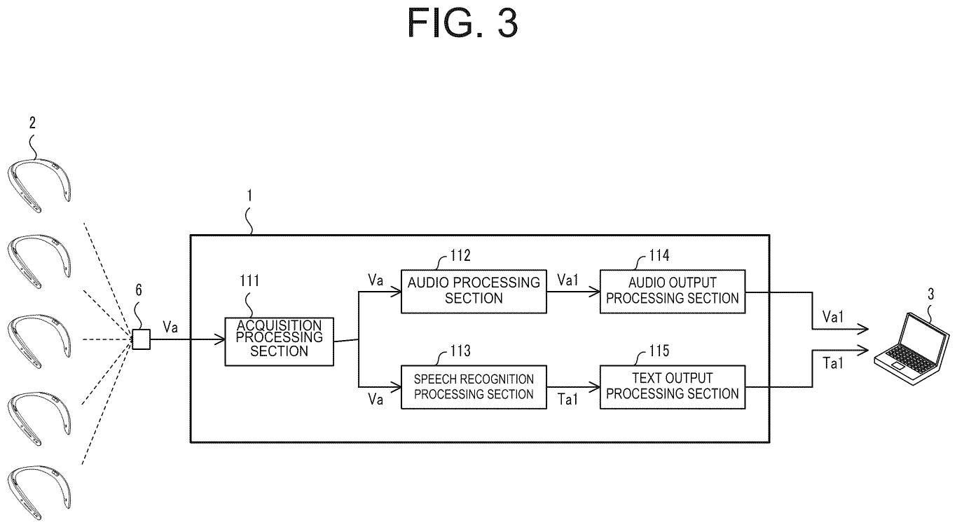

FIG. 3 schematically illustrates an example of audio processing when the audio processing device 1 is applied to a meeting. For example, when a meeting starts and a user speaks, the acquisition processing section 111 acquires the uttered audio (audio Va) input to the microphone of the user's audio device 2. The acquisition processing section 111 performs routing processing to output the audio Va to a predetermined output destination. Here, the acquisition processing section 111 outputs the acquired audio Va (audio data) to the audio processing section 112 for generating meeting audio and to the speech recognition processing section 113 for converting the audio to text.

The audio processing section 112 executes audio processing on the audio Va acquired by the acquisition processing section 111 to reproduce the audio from a speaker. Specifically, the audio processing section 112 executes at least one of echo cancellation (EC processing), noise cancellation (NC processing), and gain adjustment (AGC processing) on the audio Va. The audio processing section 112 outputs the audio subjected to the audio processing (audio Va1) to the audio output processing section 114.

Based on the audio Va acquired by the acquisition processing section 111, the speech recognition processing section 113 executes speech recognition processing to convert the audio into text. The speech recognition processing section 113 converts the audio into text using a predetermined speech recognition engine (trained model). Note that the speech recognition engine is generated by learning various audio data (training data), and the audio data is data that has not been subjected to audio processing such as echo cancellation, noise cancellation, or gain adjustment. The audio processing device 1 is equipped with the speech recognition engine.

In this way, the speech recognition processing section 113 may execute the speech recognition processing, based on the audio Va that has not been subjected to the audio processing. The speech recognition processing section 113 outputs a recognition result (text information Ta1) of the speech recognition processing for the audio Va to the text output processing section 115.

The audio output processing section 114 outputs the audio Va1, after the audio processing by the audio processing section 112, to the meeting terminal 3 in meeting room R1. The text output processing section 115 outputs the recognition result (text information Ta1) of the speech recognition processing by the speech recognition processing section 113 to the meeting terminal 3 in meeting room R1.

When the meeting terminal 3 in meeting room R1 receives the audio Va1 from the audio processing device 1, it outputs the audio Va1 to the meeting server 4 (see FIG. 1). When the meeting server 4 receives the audio Va1 from the meeting terminal 3 in meeting room R1, it outputs the audio Va1 to the meeting terminal 3 in meeting room R2. The meeting terminal 3 in meeting room R2 outputs the audio Va1 toward the users in meeting room R2.

Also, when the meeting terminal 3 in meeting room R1 receives the text information Ta1 from the audio processing device 1, it causes the text information Ta1 to be displayed on the display device 5 (see FIG. 1). As an other embodiment, the meeting terminal 3 may store the text information Ta1 to create minutes of the meeting. Also, the meeting terminal 3 may cause the text information Ta1 to be displayed on user terminals (not illustrated) of each user.

As described above, the audio processing device 1 acquires the uttered audio of each user input to each audio device 2, and transmits and receives the audio with the meeting terminal 3 and each audio device 2, thereby achieving conversations (such as an online meeting) among the users.

### Hub Device 6

### Example 1

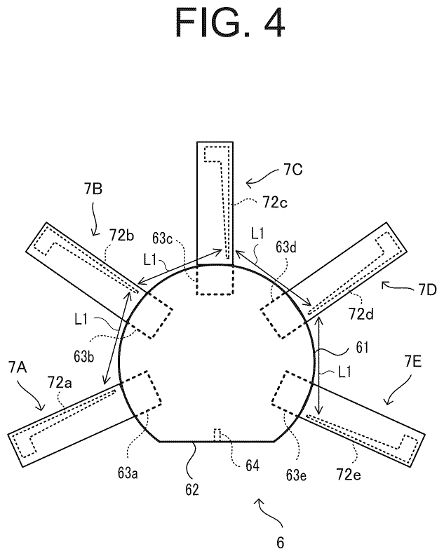

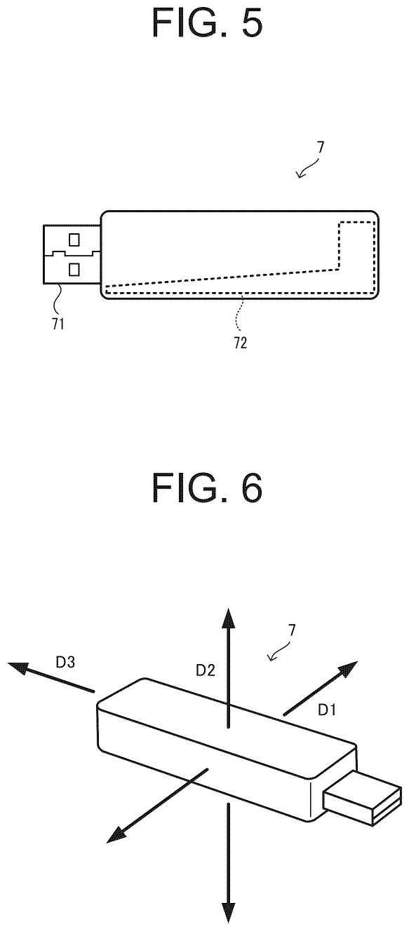

FIG. 4 is a plan view illustrating a configuration of a hub device 6 according to Example 1, and FIG. 5 is a plan view illustrating a configuration of a wireless communication transceiver 7 (Bluetooth transmitter). The wireless communication transceiver 7 includes a USB connector 71. Also, the wireless communication transceiver 7 has a built-in antenna 72 therein. A well-known product (general-purpose product) can be adopted as the wireless communication transceiver 7.

The hub device 6 has an outer shape formed by an arc-shaped first portion 61 and a straight-line-shaped second portion 62 that connects the arc. The first portion 61 constitutes a mounting surface for connecting the wireless communication transceivers 7, and the second portion 62 constitutes a mounting surface for connecting the cable 8 (see FIG. 2) that connects to the audio processing device 1.

Specifically, a connection section 64 for inserting a connection terminal of the cable 8 is arranged on the second portion 62. Also, a plurality of USB ports 63 are arranged on the arc of the first portion 61, each spaced apart by a predetermined interval.

In Example 1 illustrated in FIG. 4, five USB ports 63a to 63e (examples of connection sections of the present disclosure) are arranged on the arc of the first portion 61. The USB connector 71 of the wireless communication transceiver 7A is connected (inserted) to the USB port 63a, the USB connector 71 of the wireless communication transceiver 7B is connected to the USB port 63b, the USB connector 71 of the wireless communication transceiver 7C is connected to the USB port 63c, the USB connector 71 of the wireless communication transceiver 7D is connected to the USB port 63d, and the USB connector 71 of the wireless communication transceiver 7E is connected to the USB port 63e.

Here, the wireless communication transceiver 7 has antenna directivity in mutually different directions (D1, D2, and D3 directions), as illustrated in FIG. 6. For this reason, for example, when a plurality of wireless communication transceivers 7 are arranged in close proximity in one direction in the hub device 6, radio interference occurs. Therefore, in the hub device 6 of the present embodiment, the plurality of USB ports 63a to 63e are arranged such that, in a state where the wireless communication transceivers 7 are connected to the respective USB ports 63, a distance L1 between the closest portions of adjacent wireless communication transceivers 7 is equal to or greater than half a wavelength (λ/2) of the antenna frequency of the wireless communication transceivers 7. Also, the plurality of USB ports 63a to 63e are arranged such that the distance between adjacent USB ports 63 is equal to or greater than half a wavelength (λ/2) of the antenna frequency. Also, the plurality of USB ports 63a to 63e are arranged such that an insertion/removal direction into the USB ports 63 is radial in the hub device 6.

Specifically, as illustrated in FIG. 4, when the wireless communication transceivers 7A and 7B are adjacently connected to the USB ports 63a and 63b, the USB ports 63a and 63b are arranged such that the closest distance (shortest distance) between the antenna 72 of the wireless communication transceiver 7A and the antenna 72 of the wireless communication transceiver 7B is equal to or greater than half a wavelength (λ/2) of the antenna frequency.

Also, when the wireless communication transceivers 7B and 7C are adjacently connected to the USB ports 63b and 63c, the USB ports 63b and 63c are arranged such that the closest distance (shortest distance) between the antenna 72 of the wireless communication transceiver 7B and the antenna 72 of the wireless communication transceiver 7C is equal to or greater than half a wavelength (λ/2) of the antenna frequency.

Also, when the wireless communication transceivers 7C and 7D are adjacently connected to the USB ports 63c and 63d, the USB ports 63c and 63d are arranged such that the closest distance (shortest distance) between the antenna 72 of the wireless communication transceiver 7C and the antenna 72 of the wireless communication transceiver 7D is equal to or greater than half a wavelength (λ/2) of the antenna frequency.

Also, when the wireless communication transceivers 7D and 7E are adjacently connected to the USB ports 63d and 63e, the USB ports 63d and 63e are arranged such that the closest distance (shortest distance) between the antenna 72 of the wireless communication transceiver 7D and the antenna 72 of the wireless communication transceiver 7E is equal to or greater than half a wavelength (λ/2) of the antenna frequency.

Also, when the wireless communication transceivers 7E and 7A are adjacently connected to the USB ports 63e and 63a, the USB ports 63e and 63a are arranged such that the closest distance (shortest distance) between the antenna 72 of the wireless communication transceiver 7E and the antenna 72 of the wireless communication transceiver 7A is equal to or greater than half a wavelength (λ/2) of the antenna frequency.

For example, when the antenna frequency of the wireless communication transceivers 7 is in the 2.4 GHz band, the plurality of USB ports 63 are arranged such that the distance L1 between adjacent wireless communication transceivers 7 is approximately equal to or greater than 63 mm.

Also, As illustrated in FIG. 4, in a state where the wireless communication transceivers 7 are connected to the respective USB ports 63, the respective USB ports 63 are arranged radially in the hub device 6 such that the tip direction of each wireless communication transceiver 7 is a direction outward from the center of the hub device 6. Specifically, the USB ports 63a to 63e are arranged radially on the arc of the first portion 61 of the hub device 6 such that the tips of the wireless communication transceivers 7A to 7E face radially in the outer circumferential direction. Also, the USB ports 63a to 63e may be arranged at equal intervals on the hub device 6.

Also, as illustrated in FIG. 4, the USB ports 63a to 63e are arranged on the arc of the first portion 61 such that their respective connection directions are normal to the arc of the mounting surface of the first portion 61. As a result, the wireless communication transceivers 7A to 7E are connected to the hub device 6 such that their respective longitudinal directions match the direction from the center of the arc toward the outer circumferential side. That is, as illustrated in FIG. 4, the wireless communication transceivers 7A to 7E are connected to the hub device 6 so as to be arranged radially from the center of the arc.

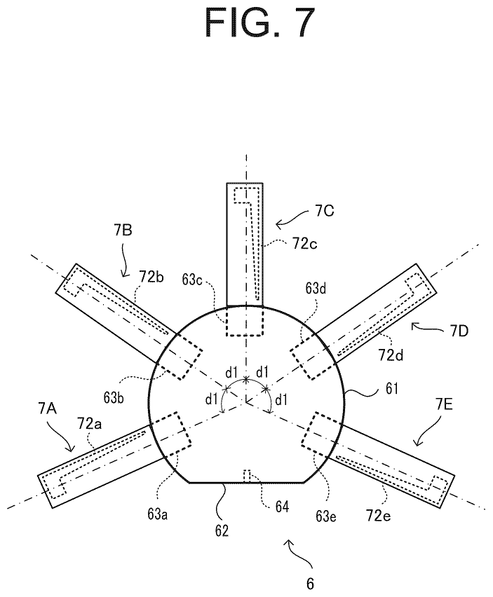

For example, the plurality of USB ports 63 are arranged such that an angular difference d1 (see FIG. 7) in the connection direction between adjacent wireless communication transceivers 7 is approximately equal to or greater than 30 degrees. Also, the plurality of USB ports 63 may be arranged such that the angular difference d1 in the connection direction between adjacent wireless communication transceivers 7 is approximately equal to or greater than 30 degrees and less than approximately 90 degrees.

According to the above configuration, since each wireless communication transceiver 7 is connected radially to the hub device 6 and each wireless communication transceiver 7 is arranged spaced apart by a distance equal to or greater than half a wavelength, radio interference can be suppressed. Therefore, deterioration in communication quality can be prevented while also preventing an increase in the size of the hub device.

### Example 2

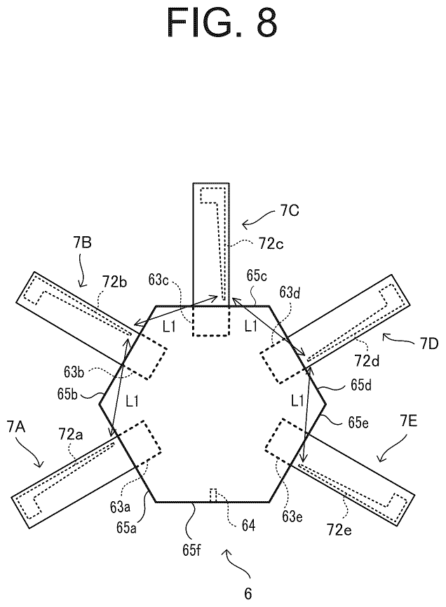

FIG. 8 is a plan view illustrating a configuration of a hub device 6 according to Example 2. The hub device 6 according to Example 2 has a polygonal outer shape. In the example illustrated in FIG. 8, the hub device 6 has a regular hexagonal outer shape composed of a first side 65a to a sixth side 65f. A plurality of USB ports 63 are arranged on each side of the polygonal mounting surface of the hub device 6.

Specifically, the USB port 63a is arranged at the center of the first side 65a, the USB port 63b is arranged at the center of the second side 65b, the USB port 63c is arranged at the center of the third side 65c, the USB port 63d is arranged at the center of the fourth side 65d, the USB port 63e is arranged at the center of the fifth side 65e, and the connection section 64 is arranged at the center of the sixth side 65f.

As in Example 1, in the hub device 6, the plurality of USB ports 63a to 63e are arranged such that, in a state where wireless communication transceivers 7 are connected to the respective USB ports 63, a distance L1 (see FIG. 8) between the closest portions of adjacent wireless communication transceivers 7 is equal to or greater than half a wavelength (λ/2) of the antenna frequency of the wireless communication transceivers 7. Also, the plurality of USB ports 63a to 63e are arranged radially in the hub device 6.

Also, as illustrated in FIG. 8, the USB ports 63a to 63e are arranged such that their respective connection directions are normal to each side. As a result, the wireless communication transceivers 7A to 7E are connected to the hub device 6 such that their respective longitudinal directions match the direction from the center of the regular hexagon toward the outer circumferential side. That is, as illustrated in FIG. 8, the wireless communication transceivers 7A to 7E are connected to the hub device 6 so as to be arranged radially from the center of the regular hexagon.

According to the configuration of Example 2, as in the configuration of Example 1, each wireless communication transceiver 7 is connected radially to the hub device 6 and the respective wireless communication transceivers 7 are arranged spaced apart by a distance equal to or greater than half a wavelength. Therefore, radio interference can be suppressed, and deterioration in communication quality can be prevented while also preventing an increase in the size of the hub device.

Note that the outer shape of the hub device 6 is not limited to a regular hexagon and may be an other polygonal shape such as a regular pentagon.

### Example 3

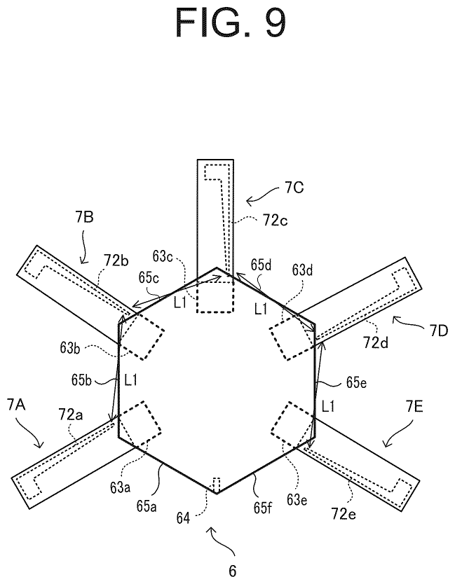

FIG. 9 is a plan view illustrating a configuration of a hub device 6 according to Example 3. The hub device 6 according to Example 3 has a polygonal outer shape (e.g., a regular hexagonal outer shape), similar to Example 2. In the hub device 6 according to Example 3, as illustrated in FIG. 9, the respective USB ports 63 are arranged at each corner of the polygon.

As in Example 2, in the hub device 6 according to Example 3, the plurality of USB ports 63a to 63e are arranged such that, in a state where wireless communication transceivers 7 are connected to the respective USB ports 63, the distance L1 (see FIG. 9) between the closest portions of adjacent wireless communication transceivers 7 is equal to or greater than half a wavelength (λ/2) of the antenna frequency of the wireless communication transceivers 7. Also, the plurality of USB ports 63a to 63e are arranged radially in the hub device 6.

Also, as illustrated in FIG. 9, the USB ports 63a to 63e are arranged such that their respective connection directions face toward the center of the hub device 6 from the corners. As a result, the wireless communication transceivers 7A to 7E are connected to the hub device 6 such that their respective longitudinal directions match the direction from the center of the regular hexagon toward the outer circumferential side. That is, the wireless communication transceivers 7A to 7E are connected to the hub device 6 so as to be arranged radially from the center of the regular hexagon.

According to the configuration of Example 3, as in the configurations of Examples 1 and 2, each wireless communication transceiver 7 is connected radially to the hub device 6 and each wireless communication transceiver 7 is arranged spaced apart by a distance equal to or greater than half a wavelength. Therefore, radio interference can be suppressed, and deterioration in communication quality can be prevented while also preventing an increase in the size of the hub device.

### Example 4

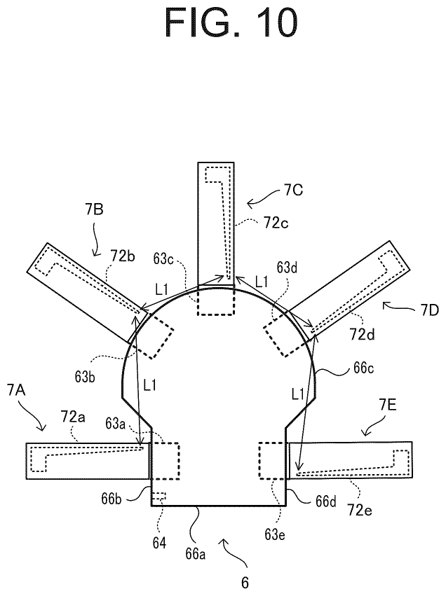

FIG. 10 is a plan view illustrating a configuration of a hub device 6 according to Example 4. The hub device 6 according to Example 4 is composed of a rectangular portion and an arcuate portion. Specifically, the hub device 6 includes a bottom 66a, a left side 66b, a right side 66d, and an arcuate section 66c connected to the left side 66b and the right side 66d. The hub device 6 is used in a posture in which the bottom 66a is in contact with a mounting surface, and the right side 66d and the left side 66b rise upward from the mounting surface. That is, the hub device 6 of Example 4 is configured to be usable on the mounting surface in an upright position (vertically placed).

The connection section 64 and the USB port 63a are arranged on the left side 66b. The USB port 63a is arranged such that its connection direction is horizontal. As a result, the wireless communication transceiver 7A is connected to the USB port 63a such that its connection direction is horizontal.

The USB port 63e is arranged on the right side 66d. The USB port 63e is arranged such that its connection direction is horizontal. As a result, the wireless communication transceiver 7E is connected to the USB port 63e such that its connection direction is horizontal.

The USB ports 63b, 63c, and 63d are arranged on an arcuate section 66c. The USB ports 63b, 63c, and 63d are arranged on the arcuate section 66c such that their respective connection directions are normal to the arc. As a result, the wireless communication transceivers 7B, 7C, and 7D are connected to the hub device 6 such that their respective longitudinal directions match the direction from the center of the arc toward the outer circumferential side. That is, as illustrated in FIG. 10, the wireless communication transceivers 7B, 7C, and 7D are connected to the hub device 6 so as to be arranged radially from the center of the arc.

Also, in the hub device 6, the plurality of USB ports 63a to 63e are arranged such that, in a state where the wireless communication transceivers 7 are connected to the respective USB ports 63, the distance L1 (see FIG. 10) between the closest portions of adjacent wireless communication transceivers 7 is equal to or greater than half a wavelength (λ/2) of the antenna frequency of the wireless communication transceivers 7. Also, the plurality of USB ports 63a to 63e are arranged radially in the hub device 6.

According to the configuration of Example 4, similarly to the configurations of Examples 1 to 3, each wireless communication transceiver 7 is connected radially to the hub device 6 and each wireless communication transceiver 7 is arranged spaced apart by a distance equal to or greater than half a wavelength. Therefore, radio interference can be suppressed, and deterioration in communication quality can be prevented while also preventing an increase in the size of the hub device. Also, since the hub device 6 can be used by being placed vertically, obstacles around the antennas 72 are eliminated, which can improve communication quality.

In each of Examples 1 to 4 described above, the position of each USB port 63 may be changeable (slidable). That is, the distance L1 between adjacent wireless communication transceivers 7 and the angular difference d1 in the connection direction between adjacent wireless communication transceivers 7 may be changeable.

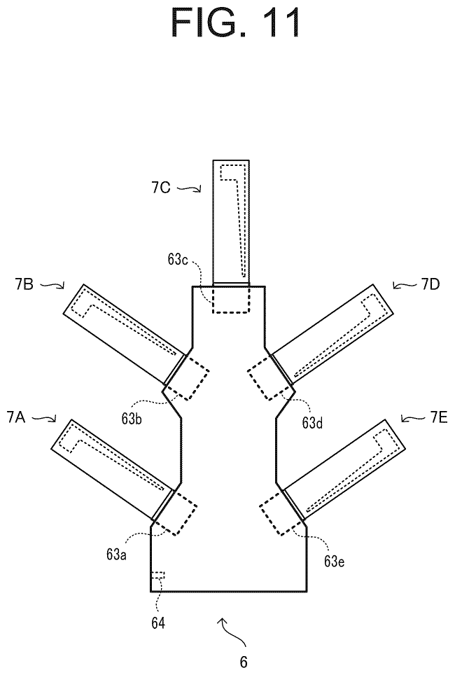

As an other embodiment, as illustrated in FIG. 11, the hub device 6 may have a tree-like outer shape. The outer shape of the hub device 6 according to the present disclosure is not limited to the embodiments described above, as long as it is an outer shape that satisfies at least the following two conditions: (1) the USB ports 63 are arranged such that, in a state where the wireless communication transceivers 7 are connected to the respective USB ports 63, the distance between the closest portions of adjacent wireless communication transceivers 7 is equal to or greater than half a wavelength of the antenna frequency, and (2) the USB ports 63 are arranged radially in the hub device 6.

As an other embodiment, the shortest distance between a plurality of arranged adjacent USB ports 63, or the center-to-center distance (pitch) in the lateral direction of the entrances of adjacent USB ports 63, may be set to be equal to or greater than half a wavelength (λ/2) of the antenna frequency of the wireless communication transceivers 7 to be used. Also, in this case, among the frequencies of the wireless communication transceivers 7 to be used, the distance may be set to be equal to or greater than half a wavelength (λ/2) of the frequency having the longest half-wavelength (λ/2) distance. For example, when the frequencies of the wireless communication transceivers 7 to be used are 2.4 GHz and 5 GHz, the distance may be set to equal to or greater than 63 mm, which is the half-wavelength (λ/2) of 2.4 GHz, as the frequency of the wireless communication transceivers 7, this half-wavelength (λ/2) distance being longer than that of 5 GHz.

As an other embodiment, when the distance between the wireless communication transceivers 7 is smaller than half a wavelength, radio interference becomes a problem, and as the distance is increased from half a wavelength, the hub device 6 itself becomes larger or the number of USB ports 63 provided in a housing of the same size decreases. Therefore, the distance between the wireless communication transceivers 7, or the distance between the antennas 72, or the distance between the USB ports 63 may be set to approximately half a wavelength (63 mm) or a range from half a wavelength up to 10% increase (110%) of the half-wavelength.

### Supplementary Disclosure

Hereinafter, an overview of the disclosure extracted from the above-described embodiments will be supplementarily described. Note that the respective configurations and respective processing functions described in the following supplementary notes can be selected or omitted and arbitrarily combined.

### <Supplementary Note 1>

A hub device that can connect to a plurality of wireless communication transceivers corresponding to respective ones of a plurality of wireless devices that operate using a common frequency band, and that enables wireless communication of the wireless devices, wherein the wireless communication transceivers are connected to respective ones of a plurality of connection sections arranged in the hub device, the plurality of connection sections are arranged such that a distance between the adjacent wireless communication transceivers, in a state where the wireless communication transceivers are connected to the respective connection sections, is equal to or greater than half a wavelength of an antenna frequency of the wireless communication transceivers, and are arranged radially in the hub device. Also, the plurality of connection sections are arranged such that the distance between the adjacent connection sections is equal to or greater than half a wavelength of the antenna frequency of the wireless communication transceivers, and an insertion/removal direction into the connection sections is arranged radially in the hub device.

### <Supplementary Note 2>

The hub device according to Supplementary Note 1, wherein the plurality of connection sections are arranged at equal intervals in the hub device.

### <Supplementary Note 3>

The hub device according to Supplementary Note 1 or 2, wherein the plurality of connection sections are arranged on an arc of an arc-shaped mounting surface of the hub device.

### <Supplementary Note 4>

The hub device according to Supplementary Note 3, wherein connection directions of the plurality of connection sections are normal to the arc of the mounting surface.

### <Supplementary Note 5>

The hub device according to Supplementary Note 1 or 2, wherein the plurality of connection sections are arranged on each side of a polygonal mounting surface of the hub device.

### <Supplementary Note 6>

The hub device according to Supplementary Note 5, wherein connection directions of the plurality of connection sections are normal to the side.

<Supplementary Note 7>

The hub device according to Supplementary Note 1 or 2, wherein the plurality of connection sections are arranged at each corner of a polygonal mounting surface of the hub device.

### <Supplementary Note 8>

The hub device according to Supplementary Note 7, wherein connection directions of the plurality of connection sections are directions that face toward a center of the polygon from the corners.

### <Supplementary Note 9>

The hub device according to any one of Supplementary Notes 1 to 8, wherein, when the antenna frequency is in the 2.4 GHz band, the plurality of connection sections are arranged such that a distance between the adjacent connection sections is equal to or greater than approximately 63 mm.

### <Supplementary Note 10>

The hub device according to any one of Supplementary Notes 1 to 9, wherein the plurality of connection sections are arranged such that an angular difference in the insertion/removal direction into the respective connection sections between the adjacent connection sections is equal to or greater than approximately 30 degrees and less than approximately 90 degrees.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A hub device that can connect to a plurality of wireless communication transceivers corresponding to respective ones of a plurality of wireless devices that operate using a common frequency band, and that enables wireless communication of the wireless devices, wherein
the wireless communication transceivers are connected to respective ones of a plurality of connection sections arranged in the hub device, and
the plurality of connection sections are arranged such that a distance between the adjacent connection sections is equal to or greater than half a wavelength of an antenna frequency of the wireless communication transceivers, and an insertion/removal direction into the connection sections is arranged radially in the hub device.

2. The hub device according to claim 1,
wherein the plurality of connection sections are arranged at equal intervals in the hub device.

3. The hub device according to claim 1,
wherein the plurality of connection sections are arranged on an arc of an arc-shaped mounting surface of the hub device.

4. The hub device according to claim 3,
wherein connection directions of the plurality of connection sections are normal to the arc of the mounting surface.

5. The hub device according to claim 1,
wherein the plurality of connection sections are arranged on each side of a polygonal mounting surface of the hub device.

6. The hub device according to claim 5,
wherein connection directions of the plurality of connection sections are normal to the side.

7. The hub device according to claim 1,
wherein the plurality of connection sections are arranged at each corner of a polygonal mounting surface of the hub device.

8. The hub device according to claim 7,
wherein connection directions of the plurality of connection sections are directions that face toward a center of the polygon from the corners.

9. The hub device according to claim 1,
wherein, when the antenna frequency is in the 2.4 GHz band, the plurality of connection sections are arranged such that the distance between the adjacent connection sections is equal to or greater than approximately 63 mm.

10. The hub device according to claim 1,
wherein the plurality of connection sections are arranged such that an angular difference in the insertion/removal direction into the respective connection sections between the adjacent connection sections is equal to or greater than approximately 30 degrees and less than approximately 90 degrees.
